(19) United States
(12) Patent Application Publication
(10) Pub. No.: US 2007/0075005 A1
(43) Pub. Date: Apr. 5, 2007

(54) Fluid filtration station

(76) Inventor: Jonathan L. Haworth, Hendersonville, TN (US)

Correspondence Address: TAYLOR & AUST, P.C., 142 SOUTH MAIN STREET, P. O. BOX 560, AVILLA, IN, 46710, US

(21) Appl. No.: 11/542,885

(22) Filed: Oct. 4, 2006

Related U.S. Application Data
(60) Provisional application No. 60/723,792, filed on Oct. 5, 2005.

(51) Int. Cl. B01D 35/00

(52) U.S. Cl. 210/172.1; 210/416.1

(57) ABSTRACT

A fluid filtration system including a storage container to which a frame is removably positioned thereon. A pump is attached to the frame, and the pump has a filter in fluid communication therewith. There is at least one snugging feature associated with the frame to secure the fluid filtration system to the storage container.

### CROSS REFERENCE TO RELATED APPLICATIONS

This is a non-provisional application based upon U.S. provisional patent application Ser. No. 60/723,792, entitled “FLUID FILTRATION STATION FOR STORAGE DRUMS”, filed Oct. 5, 2005.

### BACKGROUND OF THE INVENTION

1. Field of the Invention

The present invention relates to a fluid filtration system, and, more particularly, to a fluid filtration system removably coupled to a storage container.

2. Description of the Related Art

Numerous equipment problems can be attributed to contaminants in fluids utilized in mechanical assemblies. The problems can range from faulty equipment operation to the destruction of engine components, power transfer devices, hydraulic systems and associated control systems. Contaminants and fluids can consist of dirt particles, metal particles and shavings, chemical contaminants, water and sludge. The contaminants in the fluid can enter the system and collect in the fluid over time causing equipment wear. Additionally the contaminants can chemically attack portions of the equipment.

Depending upon the type of equipment, permanent filter systems can be included with the equipment to continuously filter and monitor the fluids flowing through the equipment. Portable fluid filtration systems are often wheeled proximate to the fluid using equipment along with the container to hold the fluid either before being filtered or thereafter.

What is needed in the art is a fluid filtration system that is easily connected to a storage container.

### SUMMARY OF THE INVENTION

The present invention provides a fluid filtration system that is coupled to the top of a storage container and provides a filtering function for the liquid contained in the container or being supplied to the container.

The invention in one form is directed to a fluid filtration system including a storage container, a frame, a pump, a filter and at least one rotatable snugging feature. The frame is removably positioned on the storage container. A pump is attached to the frame. The filter is in fluid communication with the pump. The at least one rotatable snugging feature is connected to the frame.

The present invention advantageously sits on the top of a storage drum thereby not requiring any floor space for its use.

Another advantage of the present invention is that the fluid filtration system is easily secured to the storage container by way of rotatable cams.

Yet another advantage of the present invention is that during operation any vibration caused by the pumping mechanism is dampened by its connection to the storage drum.

Still yet another advantage of the present invention is that the filtration system can be moved with the storage container.

A further advantage of the present invention is that it is light weight and easy to handle as it is moved from drum to drum.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of an embodiment of a fluid filtration system according to the present invention;

FIG. 2 is a partially sectioned view of a latch assembly of the fluid filtration system of FIG. 1;

FIG. 3 is a partially sectioned view of the latching system of FIG. 2; and

FIG. 4 is an exploded view of the latching system of FIGS. 1-3.

Corresponding reference characters indicate corresponding parts throughout the several views. The exemplification set out herein illustrates one embodiment of the invention and such exemplification is not to be construed as limiting the scope of the invention in any manner.

### DETAILED DESCRIPTION OF THE INVENTION

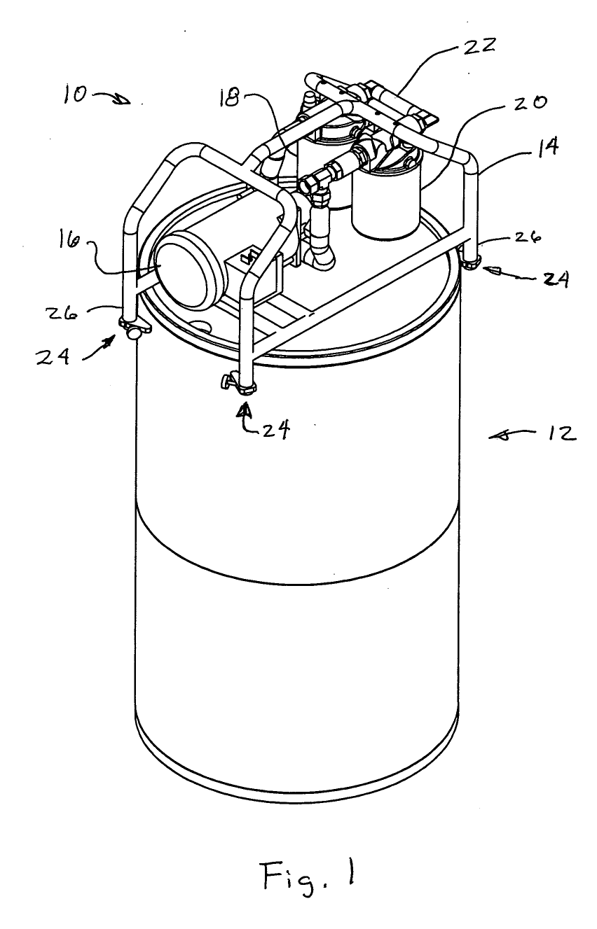

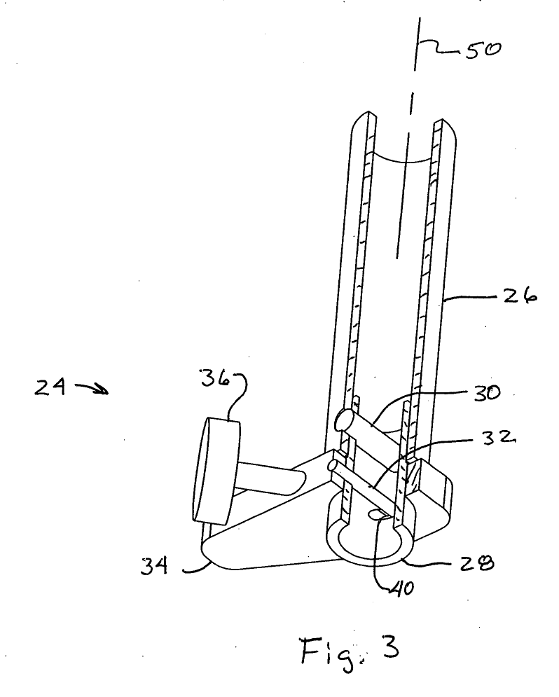

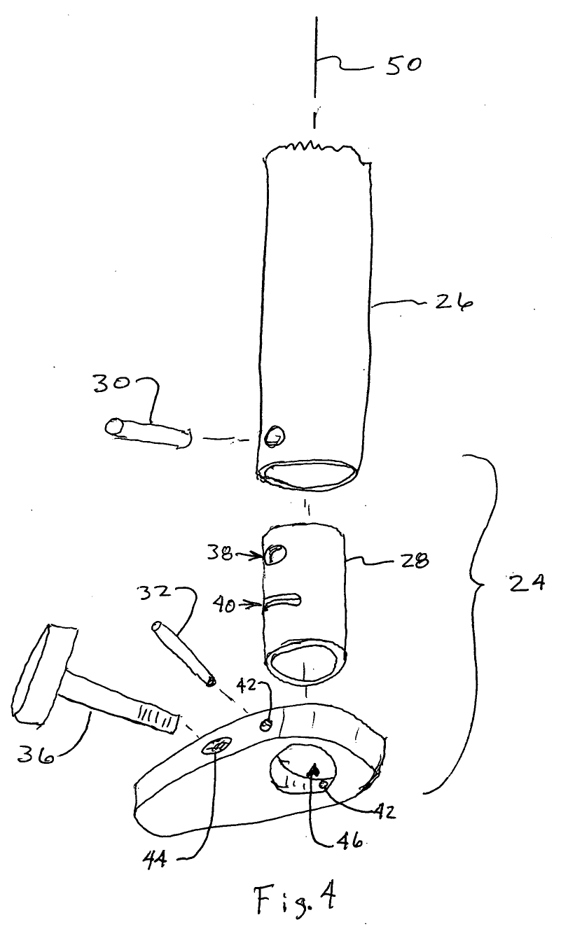

Referring now to the drawings, and more particularly to FIGS. 1-4, there is shown a fluid filtration system 10, which generally is connected to a storage container 12, and includes a frame 14, a motor/pump 16, filters 18 and 20, plumbing 22 and latch assemblies 24. Storage container 12 may be a barrel 12, which may be of a 55 gallon or 30 gallon capacity. Fluid filtration system 10 sits atop barrel 12 with a portion of frame 14 resting thereon. Pump 16 is attached to cross members of frame 14 and is in fluid communication by way of pipes 22 to filters 18 and 20. Further plumbing pipes, or conduits are connected to the system for the transportation of the fluid to/from barrel 12 and/or a piece of equipment, not shown. The additional plumbing is omitted for purposes of clarity and the actual circuit of the plumbing of a filtration system is known. Filter 18 may be a pre-filter allowing for the removal of larger particles and/or chemical contaminants and/or water. Filter 20 may be a final filter for the removal of smaller particles from the fluid that is being filtered.

Latch assemblies 24 are rotatable to snug up against a side portion of barrel 12, thereby securing fluid filtration system 10 to barrel 12. This advantageously prevents movement of system 10, which may be caused by vibrations of the moving components of system 10 or by surrounding motion of the environment, which may include a transportation system moving barrel 12. Latch assemblies 24 are quickly put into place, coming into contact with barrel 12, and are equally easy to rotate out of position for the easy removal of fluid filtration system 10 from the top of barrel 12. One portion of frame 14 along the top, serves as a handle. Side portions of frame 14 also are provided to allow an easy two-man lift with two portions of the frame being ergonomically placed for easy grasping by individuals on each side of barrel 12.

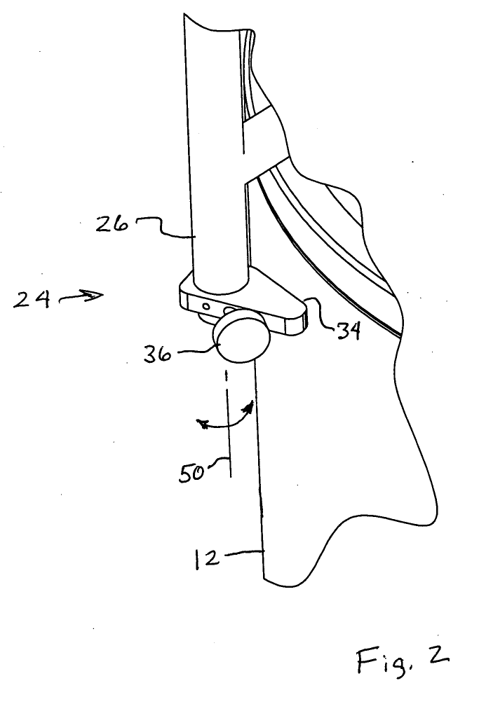

Latch assembly 24 is coaxially located with a frame portion 26 that is generally vertical in nature. Latch assembly 24 includes an insert 28, pins 30 and 32, a snugging feature 34 also known as a cam 34 and a thumb screw 36. In the embodiment illustrated there are four latch assemblies 24, one associated with each of four locations on frame 14. For ease of description, one latch assembly 24 is illustrated in FIGS. 2-4 and is discussed hereinafter although it is realized that more than one latch assembly is utilized in fluid filtration system 10. Insert 28 includes a hole 38 and a slot 40 therein. A pin 30 connects insert 28 through hole 38 to frame portion 26. Pin 30 thereby secures insert 28 to frame 14. Slots 40 allow for the rotation of cam 34 about axis 50. Cam 34 includes holes 42 to accommodate pin 32, a hole 44 for the insertion of thumbscrew 36, and a hole 46 for sliding interface with insert 28. Cam 34 is an elongated portion 34 of latch assembly 24 extending away from axis 50. Although snugging feature 34 is shown as a rotatable cam other constructs are contemplated such as a sliding device that would slide into place against barrel 12. Snugging feature 34 can also incorporate a combination of rotating and extending movement of snugging feature 34 to thereby snug fluid filtration system 10 to barrel 12.

Cam 34 extends outwardly from axis 50 allowing for contact against a side of barrel 12. Cam 34 may be made of a metallic, synthetic or other suitable material allowing for a rotational fit with insert 38 and a resilient contact with barrel 12. Cam 34 has a hole 42 through which pin 32 is used to captively hold cam 34 in a rotatable position that is generally orthogonal to axis 50. Pin 32 goes through holes 42 and through slot 40 of insert 28 to thereby define the limited rotation of cam 34. Slot 40 may limit the rotation of cam 34 to 90° rotation, or alternatively to 45° of rotation. The size of slot 40 is selected to allow pin 32 to easily slide yet not have excessive slop between pin 32 and walls of slots 40. Hole 42 tightly secures pin 32 and may be peened to prevent the removal of pin 32. Hole 44 may be a threaded hole to accommodate threads on thumbscrew 36 which are used to tighten against insert 28 thereby holding cam 34 into a desired position. Hole 46 allows cam 34 to be inserted over insert 28 during the assembly process. Hole 46 is sized to allow easy rotation of cam 34 about insert 28 and also provide a bearing surface for said rotation.

Thumbscrew 36 is a security device 36 that may also take the form of a spring loaded device that can interact with indentations or holes on insert 28 to position cam 34 in a desired location. The type of securing device 36 used also dictates the interior characteristics of hole 44. If securing device 36 is threaded then hole 44 contains corresponding threads. If security device 36 is a sliding pin then at least a portion of hole 44 will be smooth.

Fluid filtration system 10 is lifted in position by one or two individuals allowing frame 14 to rest on the top of barrel 12. Cams 34 are rotated about axes that are coaxial with a portion of frame 14 proximate to the location of each latch assembly 24. A portion of cam 34 comes into contact with a side of barrel 12 and thumbscrew 36 is tightened to thereby secure fluid filtration system 10 to storage container 12.

Hole 46 of cam 34 is placed over insert 28 so as to allow insert 28 to extend through cam 34 during the assembly process. Insert 28 is secured to an end of frame 14 by way of pin 30. This assembly allows for the limited rotation of cam 34 about axis 50 of approximately 90°, and preferably no more than approximately 45°.

Fluid filtration system 10 is secured to barrel 12 and is used to transfer fluid into and out of barrel 12 while filtering the fluid for contaminants. System 10 is secured to the top rim of drum 12 allowing for the quick discharge and transfer of system 10 to another drum. Filters 18 and 20 are a combination of an inline filter with a pressure bypass and a filter cartridge containing filtration media. The filters may also include a pressure gauge or differential pressure indicator. A desiccant breather may be connected to either a portion of fluid filtration system 10 or to an opening in barrel 12 thereby allowing only clean, dry air to enter or exit the drum as the pressure levels vary in the drum.

Advantageously, the present invention provides a fluid filtration system that easily mounts onto barrel 12 for the easy filtration of the fluid being pumped to/from barrel 12. The present invention does not utilize valuable floor space while in operation and can even be transported with the barrel upon which it is secured.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A fluid filtration system, comprising:
a storage container;
a frame removably positioned on said storage container;
a pump attached to said frame;
a filter in fluid communication with said pump; and
at least one snugging feature connected to said frame.

2. The fluid filtration system of claim 1, wherein said snugging feature contacts said storage container when rotated toward said storage container.

3. The fluid filtration system of claim 2, wherein said snugging feature includes:
an elongate portion having a side and a hole through said elongate portion; and
a securing fastener extending through said side and into said hole.

4. The fluid filtration system of claim 3, further comprising an insert that is secured to said frame and extending through said hole.

5. The fluid filtration system of claim 4, further comprising a connecting device, said insert including at least one slot, said connecting device extending from said elongate portion through said at least one slot and to said elongate portion.

6. The fluid filtration system of claim 5, wherein said connecting device is a pin that extends through holes in said elongated portion.

7. The fluid filtration system of claim 6, wherein said securing fastener interacts with said insert to immobilize said elongate portion.

8. The fluid filtration system of claim 7, wherein said securing fastener is one of a threaded device and a biased device.

9. A fluid filtration system for interaction with a fluid storage container, comprising:
a frame;
a pump attached to said frame;
a filter in fluid communication with said pump; and
at least one of a cam and a sliding device connected to said frame and configured to contact the storage container.

10. The fluid filtration system of claim 9, wherein said cam is configured to contact the fluid storage container when said cam is rotated toward the storage container.

11. The fluid filtration system of claim 9, wherein said cam has a hole therethrough and said cam including:
a side; and
a securing fastener extending through said side and into said hole.

12. The fluid filtration system of claim 11, further comprising an insert that is secured to said frame and extends through said hole.

13. The fluid filtration system of claim 12, further comprising a connecting device, said insert including at least one slot, said connecting device extending from said cam through said at least one slot and to said cam.

14. The fluid filtration system of claim 13, wherein said connecting device is a pin that extends through holes in said cam.

15. The fluid filtration system of claim 14, wherein said securing fastener interacts with said insert to immobilize said cam.

16. The fluid filtration system of claim 15, wherein said securing fastener is one of a threaded device and a biased device.

17. A method of securing a fluid filtration system to a storage container, comprising the steps of:
providing a pump attached to a frame;
resting said frame on the fluid storage container; and
rotating a cam about an axis that is coaxial with a portion of said frame to contact the storage container.

18. The method of claim 17, further comprising the step of securing said cam from rotating relative to said frame.

19. The method of claim 18, further comprising the steps of:
securing an insert to an end of said frame; and
extending said insert through said cam.

20. The method of claim 17, further comprising the step of constraining said rotating step such that rotation of said cam is limited to no more than approximately 90°.
